(19) United States
(12) Patent Application Publication
(10) Pub. No.: US 2008/0300133 A1
(43) Pub. Date: Dec. 4, 2008

(54) Oxygen Scavenger/Indicator

(75) Inventors: Horst-Christian Langowski, Zolling (DE); Thomas Wanner, Schrobenhausen (DE)

Correspondence Address: KAPLAN GILMAN GIBSON & DERNIER L.L.P., 900 ROUTE 9 NORTH, WOODBRIDGE, NJ, 07095, US

(73) Assignee: Fraunhofer-Gesellschaft Zur Forderung Der Angewandten Forschung E.V., Munchen (DE)

(21) Appl. No.: 12/093,165

(22) PCT Filed: Nov. 17, 2006
(86) PCT No.: PCT/EP06/11075

§ 371 Date: May 9, 2008

(30) Foreign Application Priority Data
Nov. 22, 2005 (DE) 10 2005 055 634.5

(51) Int. Cl. B01J 20/02; B01J 20/22

(52) U.S. Cl. 502/401; 502/400; 502/406

(57) ABSTRACT

The invention relates to an oxygen scavenger/indicator which contains at least one oxygen sorbent comprising a metal or a metal compound which can be transferred by oxygen into a higher oxidation level. Furthermore, a complexing agent or redox indicator for the sorbent and also an electrolyte are contained in addition. The indicator effect is effected by a change in the physical properties of the oxygen sorbent which is initiated by complex formation and/or interaction with the redox indicator.

### FIELD OF THE INVENTION

The invention relates to an oxygen scavenger/indicator which contains at least one oxygen sorbent comprising a metal or a metal compound which can be transferred by oxygen into a higher oxidation level. Furthermore, a complexing agent or redox indicator for the sorbent and also an electrolyte are contained in addition. The indicator effect is effected by a change in the physical properties of the oxygen sorbent which is initiated by complex formation and/or interaction with the redox indicator.

### BACKGROUND

O₂ scavengers are materials which can sorb oxygen. There should be understood here by sorption all the known sorption possibilities, e.g. adsorption, absorption, chemical adsorption and physical adsorption. The systems established at present according to the state of the art can be qualified here primarily according to the O₂ scavenger substrate and according to the initialisation mechanism thereof. The following groups are hereby differentiated:
inorganic O₂ scavengers, e.g. iron-based or sulphide-based systems
low molecular organic O₂ scavengers, e.g. ascorbate-based systems high molecular organic O₂ scavengers, e.g. polyolefin-based or polyamide-based systems

O₂ scavengers are thereby initialised either by UV radiation or by moisture. This means that the O₂ scavenger function is present only after exposure to UV radiation or water, i.e. air moisture.

Indicator systems can be subdivided in general into time-temperature indicator (TTI), gas/leakage indicator and freshness indicator systems. A TTI integrates the time-temperature history of a product and hence provides direct evidence about the storage conditions thereof. The indicator effect is effected by a chemical reaction or by counter-diffusion of two colourants.

Gas leakage indicators detect the gas concentration of O₂, CO₂ or H₂O in the packaging space. Hence they provide direct evidence about the quality of the product. The indicator effect is caused by a chemical reaction with the reactands O₂, CO₂ or H₂O.

Freshness indicators detect the metabolic products of microorganisms and hence provide direct evidence about the quality of the product. The indicator effect is caused by a chemical reaction of the metabolic products.

It is common to all these indicator systems that the indicator effect is reproduced by a visible colour change.

Hence there is a large number of O₂ scavenger systems in the state of the art but only a decreasingly low number of gas-leakage indicator systems.

### SUMMARY OF THE INVENTION

Combined O₂ scavenger/indicator systems are at present not known in the state of the art. In the case of these, the O₂ scavenger operates independently of the O₂ indicator, i.e. the O₂ indicator signals merely that a certain O₂ concentration is exceeded.

Starting herefrom, it was the object of the present invention to provide on O₂ scavenger/indicator system which can signal visually or metrologically that a certain O₂ concentration is exceeded, that a certain O₂ concentration timespan is exceeded and that a certain absorbed oxygen quantity of the O₂ scavenger is exceeded.

This object is achieved in one embodiment by an oxygen scavenger/indicator containing at least one oxygen sorbent comprising a metal or a metal compound which can be transferred by oxygen into a higher oxidation level, at least one complexing agent and/or redox indicator for the metal or the metal compounds in the oxidised form, at least one physical property of the oxygen sorbent being changed by complex formation and/or interaction with the redox indicator, and also containing at least one electrolyte; and in another embodiment by a composite system containing at least one carrier layer and at least one oxygen scavenger/indicator. Further embodiments are disclosed herein revealing advantageous developments. The composite systems disclosed herein may be used as packaging film such as for foodstuffs.

### BRIEF DESCRIPTION OF THE DRAWINGS

Various variants of the subject according to the invention are intended to be represented with reference to the subsequent Figures and examples without restricting said subject to the embodiments shown here.

FIG. 1 shows the oxygen absorption and colour change of oxygen scavenger/indicators according to the invention with reference to a diagram.

FIG. 2 shows the oxygen absorption over time of an oxygen scavenger/indicator according to the invention which is incorporated in a composite system according to the invention.

FIG. 3 shows the dependency of the electrical resistance of an oxygen scavenger/indicator according to the invention upon the consumed oxygen quantity with reference to a diagram.

FIG. 4 shows the dependency of the UV/visible absorption of an oxygen scavenger/indicator according to the invention upon the consumed oxygen quantity with reference to a diagram.

### DETAILED DESCRIPTION OF THE INVENTION

According to the invention, an oxygen scavenger/indicator is provided which contains at least one oxygen sorbent comprising a metal or a metal compound. The metal or the metal compound can be transferred into a higher oxidation level by means of oxygen, i.e. with oxygen found in the environment. Furthermore, the oxygen scavenger/indicator contains at least one complexing agent and/or redox indicator for the metal or the metal compound in the oxidised form. The complex formation and/or the interaction with the redox indicator thereby initiates a change in at least one physical property of the oxygen sorbent. As a further component, the oxygen scavenger/indicator contains an electrolyte which assists the electron transfer of the redox reaction.

The oxygen sorbent can thereby change one of its physical parameters under oxygen exposure. With respect to the relevant physical properties, there are no restrictions as long as they represent a visual or metrologically evaluatable change.

There should be mentioned hereby as physical properties for example the magnetism, electrical conductivity and electromagnetic absorption.

In a first variant, the oxygen sorbent represents a magnetic or specifically magnetised material, such as e.g. elementary iron, which is converted by contact with oxygen into a non- or low-magnetic compound, such as e.g. FeₓO_{y}. The thereby occurring change in permeability or magnetic remanence can be detected by e.g. a sensor. For the magnetic remanence, a magnetometer can be used here whilst the change in permeability can be detected by an inductivity measurement.

Another preferred embodiment provides that the oxygen sorbent is an electrically conductive material, such as e.g. elementary iron, and is converted by exposure to oxygen to a non- or low-electrically conductive compound, such as e.g. FeₓO_{y}. The change in electrical conductivity can thereby be detected for example by means of a sensor. Coupling of the current is effected by inductive or capacitive routes. The detection during the inductive coupling can thereby be effected preferably by means of eddy current measuring technology. In the case of capacitive coupling, detection can be effected preferably according to the condenser principle.

A further preferred variant provides that the electromagnetic absorption of the oxygen sorbent is changed. Elementary iron is used for example hereby as oxygen sorbent which is converted to an oxidic compound, e.g. FeₓO_{y}, under exposure to oxygen. The electromagnetic adsorption of the oxygen sorbent thereby changes. This can be detected for example by means of a sensor. Preferably, photometers or IR measuring appliances are used as detectors for the UV/IR range. Detection is likewise possible in the visible range and in the microwave range. A visually perceivable colour change in the oxygen sorbent is particularly preferred.

Water serves preferably as trigger for the reaction with oxygen, i.e. the air moisture found in the environment. The electrolyte is liquefied by the air moisture, as a result of which the electron transfer for the redox reaction is made possible. After a certain relative air moisture, the result is hence initialisation of the system, the relative moisture of the initialisation being able to be determined by the choice of the electrolyte. A typical value when using sodium chloride as electrolyte for initiation of the O₂ scavenger/indicator system is at ≧75% moisture.

The oxygen scavengers/indicators according to the invention are based on materials comprising a redox pair or a metal and a complexing agent which combine both the O₂ scavenger and the O₂ indicator function in themselves. Hence the O₂ scavenger and indicator has the same reaction kinetics.

For the combined system according to the invention, this implies the further advantage that the correlation of the absorbed oxygen quantity of the O₂ scavenger with the colour change in the O₂ indicator is independent of the temperature.

A system with one material for the O₂ scavenger function and with a further material for the O₂ indicator function has, in contrast hereto, two reaction kinetics and hence two different temperature dependencies. This means that the correlation of the residual capacity of the O₂ scavenger with the colour change in the O₂ indicator is temperature-dependent.

Preferably, the at least one oxygen sorbent is present in solid or dispersely dissolved form.

Preferably, the oxygen sorbent is a metal selected from the group comprising iron, zinc, aluminium, cobalt, nickel, copper, magnesium, chromium and tin.

With respect to the redox indicator or complexing agent for the oxygen sorbent, all the compounds which can effect a colour change in the sense of an oxygen scavenger/indicator are suitable. These are hence all the compounds which serve as redox indicator for the corresponding metal or the metal compounds, or compounds which can be used as complexing agents for the metal or the metal compound. Preferably, there are used as redox indicator or complexing agent those compounds selected from the group comprising 2,2′-bipyridine, 1,10-phenanthroline, 1,10-phenanthroline hydrochloride, ethylene diaminetetraacetic acid (EDTA), potassium hexacyanoferrate (II), potassium hexacyanoferrate (III), potassium thiocyanate, salicylic acid, methylsalicylate, sulphosalicylic acid, acetylsalicylic acid, ethylacetoacetate, phosphorus acid, catechin, benzcatechin, hydroquinone, resorcinol, gallic acid and pyrogallol.

All the compounds which assist the electron transfer of the redox action are suitable as electrolyte. Compounds from the group of alkali and alkaline earth metal halogenides are hereby used preferably. However it is also possible likewise to use metallic and non-metallic sulphates and phosphates but also non-metallic halogenides, such as ammonium chloride.

These electrolytes can be present both in liquid and in solid form.

A further preferred variant provides that the oxygen scavenger/indicator contains a polymer electrolyte and/or a gel electrolyte. There can be used as polymer electrolytes, in particular polymers in combination with salts, such as e.g. polyethyloxide (PEO) with LiPF₆, polypropylene oxide (PPO) with LiCF₃FO₃ or polyethylene oxide with LiClO₄ and possibly TiO₂. As gel electrolytes there are used particularly preferably systems comprising polyether, polycarbonate and LiBF₄, systems comprising polyacrylonitrile (PAN), polycarbonate (Pc), electrochromic polymers and LiClO₄ and systems comprising polyvinylchloride (PVC), dioctyladipate (DOA) and LiN(SO₂CF₃)₂.

A preferred embodiment of the oxygen scavenger/indicator provides that the latter contains in addition an activator for the oxygen sorbent. There are preferred in particular as such an activator, compounds from the group chromium, silver, copper or tin.

Although the object according to the invention is achieved by all the compounds described here in general, some particularly preferred embodiment variants exist.

A first preferred oxygen scavenger/indicator comprises iron as oxygen sorbent which is then combined with a redox indicator for the oxidation of Fe(0) into Fe(II) or with a complexing agent for Fe(II). The iron is thereby oxidised by the oxygen in the environment into Fe(II) which in turn forms with the complexing agent a coloured complex which can be perceived by the observer as a colour change.

Another system is based on the fact that iron is used as oxygen sorbent, a redox indicator for the oxidation of Fe(II) into Fe(III) being contained as redox indicator or a complexing agent for Fe(III). In this system, the colour change is effected in that either the redox indicator is coloured during the oxidation into Fe(III) or a coloured Fe(III) complex is formed.

A third particularly preferred variant is based on a Fe(II) salt as oxygen sorbent which is combined with a redox indicator for the oxidation of Fe(II) into Fe(III) or a complexing agent for Fe(III). In this case, the colour change is effected by the redox indicator during the oxidation into Fe(III) or by the formation of a coloured Fe(III) complex.

Another particularly preferred variant provides that iron is present as oxygen sorbent, the latter being combined with one redox indicator for the oxidation of Fe(0) into Fe(II) and one redox indicator for the oxidation of Fe(II) into Fe(III). Another possibility resides in the combination with respectively one complexing agent for Fe(II) and for Fe(III). The colour change here is essentially achieved by the oxidation of Fe(0) into Fe(III).

A preferred embodiment of the oxygen scavenger/indicator according to the invention is composed of 60 to 94.5% by weight of the at least one oxygen sorbent, 5 to 30% by weight of the at least one redox indicator or complexing agent and 0.5 to 10% by weight of the at least one electrolyte. These data relate to the total weight of the oxygen scavenger/indicator.

With respect to the composition, a second preferred embodiment of the oxygen scavenger/indicator according to the invention comprises up to 15 to 69.5% by weight of the at least one oxygen sorbent, up to 30 to 75% by weight of the at least one redox indicator or complexing agent and up to 0.5 to 10% by weight of the at least one electrolyte.

A third preferred embodiment relates to an oxygen scavenger/indicator which comprises up to 30 to 70% by weight of an oxygen sorbent, up to 10 to 20% by weight of the Fe(II) complexing agent and up to 20 to 40% by weight of the Fe(III) complexing agent.

The oxygen scavenger/indicator according to the invention has the particular feature that the weight ratio of oxygen sorbent to redox indicator or complexing agent and electrolyte can be adjusted such that the oxygen scavenger/indicator changes at least one of its physical properties at a defined time which reproduces the residual capacity of the oxygen sorbent. Included herein is particularly preferably a colour change point.

A further variant according to the invention provides that the weight ratio of oxygen sorbent to redox indicator or complexing agent and electrolyte is adjusted such that the oxygen scavenger/indicator changes at least one of its physical properties at a defined time which indicates that a specific oxygen concentration is exceeded. In particular a colour change point of the oxygen scavenger/indicator is included in these physical properties.

A third variant provides that the weight ratio of oxygen sorbent to redox indicator or complexing agent and the at least one electrolyte is adjusted such that the oxygen scavenger/indicator has a change in its physical properties at a defined time which indicates that a specific oxygen concentration timespan is exceeded. As a preferred physical property, there applies here also electromagnetic absorption, i.e. the change in colour of the sorbent. By means of the colour change point, a defined residual capacity of the oxygen sorbent is intended to be signalled visually or with the help of a measurement.

All three previously mentioned variants according to the invention can of course also be combined with each other.

It is preferred in addition that at least one of the components of the oxygen scavenger/indicator is contained in encapsulated form. There is included herein in particular that the oxygen scavenger/indicator contains water in encapsulated form. Water capsules of this type can then be destroyed by mechanical stress, as a result of which the water contained in the capsule is released and serves as carrier for the oxygen scavenger/indicator.

Fundamentally, the oxygen scavenger/indicator can be present in two variants, i.e. as non-visible and visible variant. The visible variant thereby enables visual perception and evaluation, which generally is adequate with respect to qualitative evaluations. The non-visible variant is based in turn on the change in other physical properties which, as described previously, can be evaluated with corresponding measuring instruments and thus can also provide in addition quantitative results. In particular for the packager and the seller of products, e.g. foodstuffs, information about how the headroom atmosphere in the packaging behaves is often important. Furthermore, with establishment of active packagings with O₂ scavengers, knowledge about the residual consumption capacity of the scavenger in the packaging, e.g. at the time of packaging, is of the greatest interest. These requirements can be achieved outstandingly with the described indicator systems.

According to the invention, a composite system is likewise provided, which contains at least one carrier layer and at least one oxygen scavenger/indicator, as described previously.

Preferably, the at least one oxygen scavenger/indicator is thereby enclosed between the at least one carrier layer and at least one further layer in the manner of a sandwich. The at least one oxygen scavenger/indicator can thereby be disposed for example in solid, disperse or dissolved form at points between the layers. It is likewise possible that the at least one oxygen scavenger/indicator is disposed in solid, disperse or dissolved form in a planar manner between the layers, for example in the form of a film. With respect to the point-wise arrangement of the oxygen scavenger/indicator, it is possible to dispose an oxygen scavenger/indicator with an oxygen scavenger spatially separated from each other. The number of systems of this type which are separated from each other spatially is not thereby restricted.

The at least one further layer can be modified by foaming and/or stretching. In this way, it is possible to influence the oxygen permeability of the composite system subsequently.

The at least one oxygen scavenger/indicator can be embedded in a polymer layer, e.g. comprising polyethylene. It is likewise possible that the at least one oxygen scavenger/indicator is embedded in an adhesive backing layer, a paint layer or printed ink layer.

The described composite systems are outstandingly suitable as packaging films for any packaging item, in particular foodstuffs, and also as an individual film within a commercial, electrical appliance.

The fields of application thereby relate to the foodstuffs industry, pharmaceutical products and appliances, the electronics industry, the chemical industry, but also cultural and military fields.

### EXAMPLE 1

### Oxygen-Consuming/-Indicating Powder Mixture (Fe+Various Salts)

The dependency of the quantity ratio of additive to scavenger and the various additives is represented with reference to the subsequent tables. The systems described here are based on iron as oxygen sorbent.

In table 1, tests relating to powder mixtures of iron with sodium chloride (1.5% by weight relative to the iron mass) and various additives (respectively 3% by weight relative to the iron mass) are represented in table 1. The interaction of additive with the degree of discolouration with an absorbed oxygen quantity of 215 cm³/g is hereby represented.

TABLE 1
Mixture Surface area proportions of discoloured sample [%] with an
absorbed oxygen quantity of 215 cm³/g

| | | |
|---|---|---|
| Fe + | — | 20 |
| | Na₂SO₄ | 70 |
| | K₂SO₄ | 80 |
| | CaSO₄ | 90 |
| | FeSO₄ | 90 |
| | CaO | 100 |
| | Na₂CO₃ | 100 |

In table 2, powder mixtures of iron with 1.5% by weight of sodium chloride (relative to the iron mass) and 3% by weight of FeSO₄ (relative to the iron mass) are represented. The degree of discolouration is thereby dependent upon the absorbed oxygen quantity (capacity 300 cm³/g).

TABLE 2

| Proportion of surface area | |
|---|---|
| discolouration [%] | Absorbed oxygen quantity [cm³/g] |
| 10 | 68 |
| 80 | 177 |
| 90 | 200 |
| 100 | 240 |

In table 3, powder mixtures of iron with 1.5% by weight of sodium chloride (relative to the iron mass) and 3% by weight of CaO (relative to the iron mass) are represented. The degree of discolouration is thereby dependent upon the absorbed oxygen quantity (at most capacity 300 cm³/g).

TABLE 3

| Proportion of surface area | |
|---|---|
| discolouration [%] | Absorbed oxygen quantity [cm³/g] |
| 10 | 11 |
| 60 | 130 |
| 100 | 151 |

In table 4, polyethylene extrudates of iron with sodium chloride with different sodium chloride concentrations (relative to the iron mass) are represented. The table thereby shows the interaction of the sodium chloride concentration with the degree of discolouration with an absorbed oxygen quantity of 20 cm³/g.

TABLE 4
Extrudate Surface area proportion of discoloured sample [%] with an
absorbed oxygen quantity of 20 cm³/g

| Fe + | 1% by wt. NaCl | no significant discolouration |
|---|---|---|
| | 5% by wt. NaCl | |
| | 10% by wt. NaCl | 80 |
| | 20% by wt. NaCl | 80 |
| | 40% by wt. NaCl | 50 |
| | 60% by wt. NaCl | 30 |

### EXAMPLE 2

### Oxygen-Consuming/-Indicating Powder Mixtures (Fe+NaCl+Complexing Agent)

In addition, tests were implemented on powder mixtures which have oxygen-consuming or -indicating properties. The compositions of these powder mixtures can be deduced from table 5.

TABLE 5

| | |
|---|---|
| gallic acid + Fe | 80 mg Fe + 250 mg gallic acid |
| gallic acid + Fe + NaCl | 80 mg Fe + 250 mg gallic acid + 13 mg NaCl |
| salicylic acid + Fe + | 80 mg Fe + 317 mg salicylic acid + |
| NaCl + NaOH | 13 mg NaCl + 67 mg NaOH |

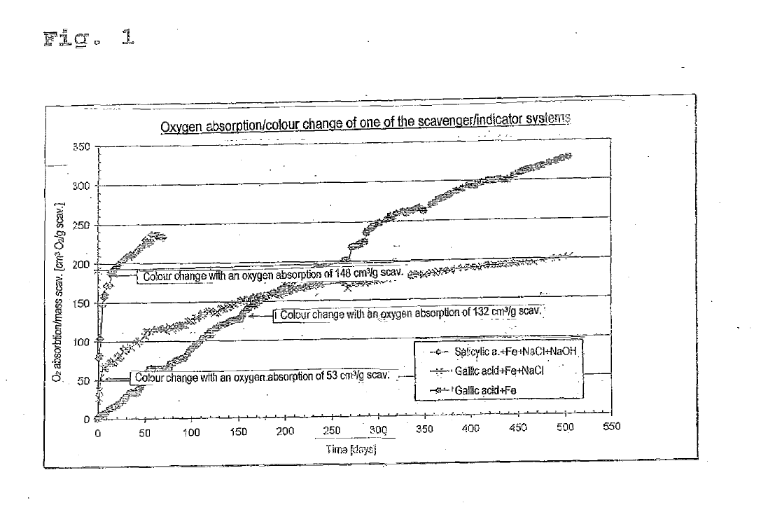

In FIG. 1, the oxygen absorption and the colour change (white to purple) of the powder mixtures gallic acid+Fe, gallic acid+Fe+NaCl and salicylic acid+Fe+NHCl+NaOH is represented.

Because of the different mixtures of different complexing agents and additives, the oxygen absorption kinetics and the maximum oxygen absorption can be influenced. Furthermore, the colour change as a function of the absorbed oxygen quantity can be adjusted as a result. By means of suitable powder mixtures, the oxygen absorption kinetics, the maximum oxygen absorption and the colour change with a specific absorbed oxygen quantity can be adjusted.

### EXAMPLE 3

### Test of the O₂ Indicator Characteristic of Powder Mixtures of Fe(II) Salts and Fe(III) Complexing Agents

If a powder mixture comprising an iron (II) salt and an iron (III) complexing agent, listed in table 6, is stored at 100% relative moisture and at an oxygen concentration of 21% and 23° C., then after some time the result is a colour change in the pile of powder. This is because the iron (II) ions are oxidised by the air oxygen and the moisture into iron (III) ions and these form a coloured complex with the iron (III) complexing agent. According to the iron salt and the complexing agent, the colour and the induction time, i.e. duration until colour change, differ (see table 6).

TABLE 6

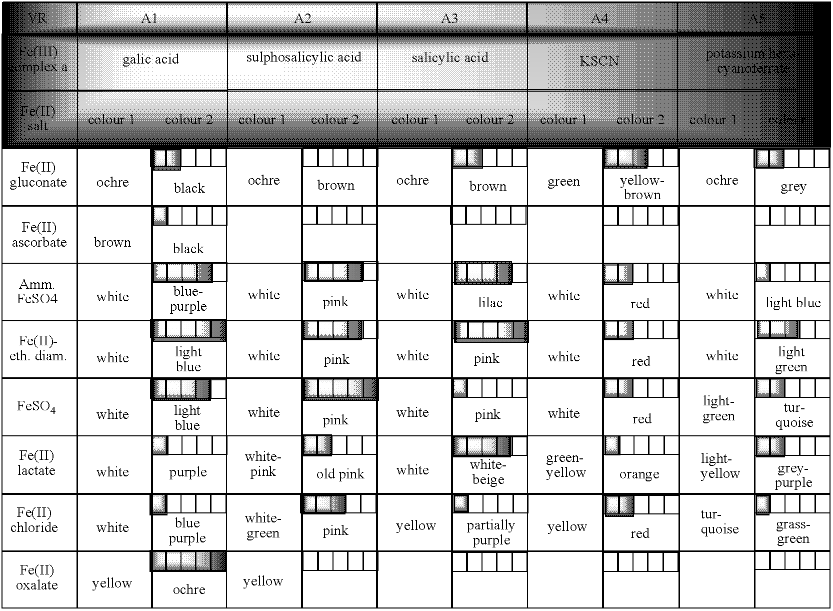

In table 6, the time duration until the colour change of the tested mixtures is represented by the number of small coloured boxes. The time scale was established thereby as follows:
1 h 3 h 9 h 18 h>18 h

Three coloured boxes accordingly correspond to a colour change within three to nine hours. “Colour 1” indicated for each powder mixture corresponds to the initial colour of the mixture. “Colour 2” is respectively the colour of the mixture after the Fe(III) complex has formed.

It can be seen from the results in Table 6 that both colour and induction time vary very greatly as a function of Fe(II) salt and Fe(III) complexing agent. According to the Fe(III) complexing agent respectively, the Fe(III) complex is in fact a characteristic colour but the colour tone is dependent upon the cation of the iron salt which is used. Gallic acid forms, with oxidised iron (II) salts, a light blue to black complex, sulphosalicylic and salicylic acid form relatively pale pink to lilac complexes, potassium thiocyanate very rapidly forms dark red complexes and potassium hexacyanoferrate forms complexes in various shades of turquoise.

Fe(II) oxalate is of very low reactivity, even after a week the result is no colour change. The mixtures with Fe(II) gluconate and -ascorbate change their colour only slightly since the salts themselves already have a brownish appearance. The remaining mixtures have, according to the combination of Fe(II) salt and Fe(III) complexing agent respectively, induction times of less than 1 hour to more than 18 hours.

### EXAMPLE 4

### Oxygen-Consuming/-Indicating Packaging Material

The changing point of the O₂ scavenger/indicator can be adjusted via the quantity ratio of additives to scavenger and also via the quantity ratio of indicator to scavenger. In table 7, this dependency is represented by way of example for an Fe scavenger with gallic acid as indicator for different NaCl concentrations. The system is located in the acrylate-based adhesive backing system (KK) with which the multilayer packaging PET/SiOₓ/KK/PA was produced.

The acrylate-based adhesive system thereby contains 10% by weight of iron with 5% by weight of gallic acid and various NaCl concentrations. The interaction between colour change and absorbed oxygen quantity can be deduced from table 7.

TABLE 7

| | | Colour change with an |
|---|---|---|
| | | absorbed oxygen quantity |
| Backing | | [cm³/g] of |
| Fe + gallic acid + | 1% by wt. NaCl | no significant discolouration |
| | 3% by wt. NaCl | 36 |
| | 5% by wt. NaCl | 50 |
| | 10% by wt. NaCl | 76 |
| | 20% by wt. NaCl | 91 |

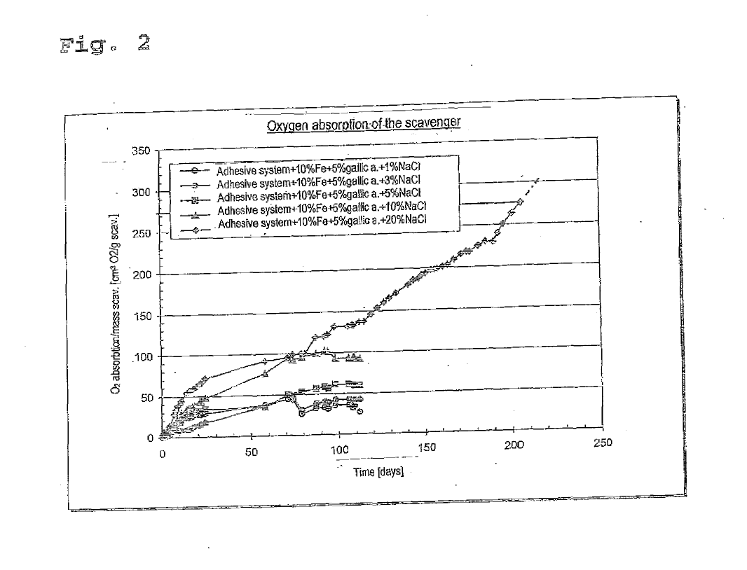

FIG. 2 shows the oxygen absorption over time of the O₂ scavenger/indicator based on iron, gallic acid and sodium chloride with various sodium chloride concentrations. The system is incorporated in the adhesive backing (KK) of the multilayer packaging which comprises PET/SiOₓ/KK/PA.

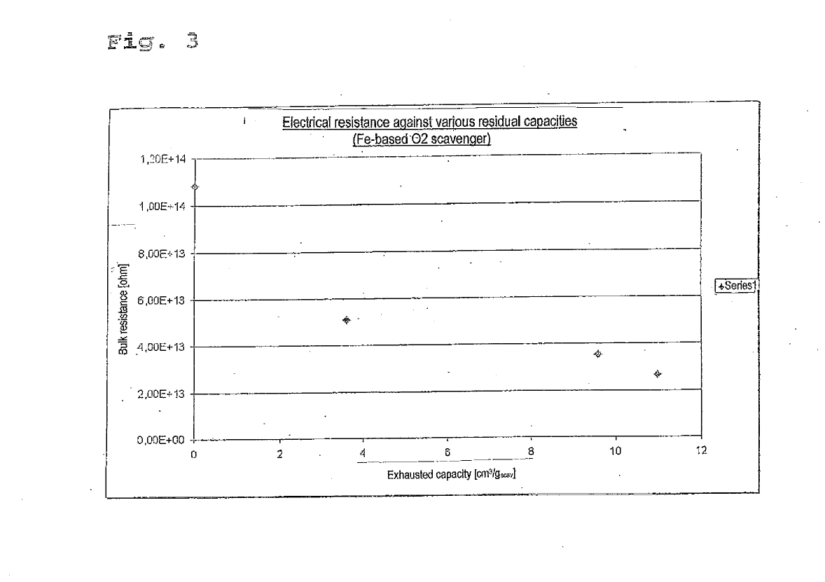

The residual capacity of the O₂ scavenger/indicator system by detection of electrical resistance as a function of the absorbed oxygen quantity of the O₂ scavenger is likewise possible. Thus FIG. 3 shows the dependency of the electrical resistance of an iron-based oxygen-consuming PE film upon the consumed oxygen quantity, i.e. the exhausted capacity. The bulk resistance through the film reduces with increasing consumed oxygen quantity of the oxygen scavenger. As a result of this correlation, the consumed quantity of oxygen or the residual capacity of the O₂ scavenger can be detected metrologically.

Another possibility resides in determining the residual capacity of the O₂ scavenger/indicator system by detection of the electromagnetic absorption in the UV/visible range as a function of the absorbed oxygen quantity of the O₂ scavenger system.

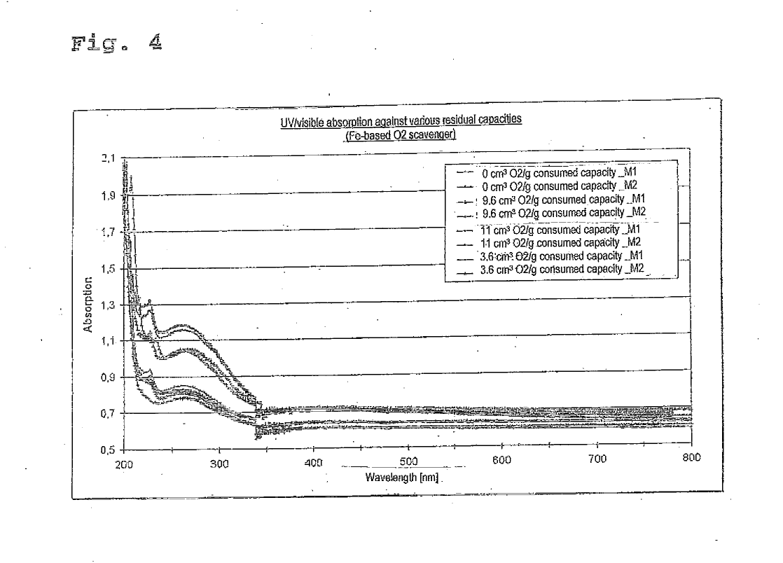

Thus FIG. 4 shows the dependency of the UV/visible absorption of an iron-based oxygen-consuming PE film upon the consumed oxygen quantity, i.e. the exhausted capacity. The film with increasing consumed oxygen quantity, i.e. an exhausted capacity of 0 to 11 cm³/g, shows an increase in the intensity of the local absorption maximum at approx. 260 nm of 0.8 to 1.2. As a result of this correlation, the consumed quantity of oxygen or the residual capacity of the O₂ scavenger can be detected metrologically.

1. An oxygen scavenger/indicator comprising at least one oxygen sorbent comprising a metal or a metal compound which can be transferred by oxygen into a higher oxidation level, at least one complexing agent and/or redox indicator for the metal or the metal compounds in the oxidised form, at least one physical property of the oxygen sorbent being changed by complex formation and/or interaction with the redox indicator, and also comprising at least one electrolyte.

2. An oxygen scavenger/indicator according to claim 1, wherein the oxygen sorbent physical properties include magnetism, electrical conductivity and/or electromagnetic absorption and the magnetism, the electrical conductivity and/or the electromagnetic absorption of the oxygen sorbent changes during the sorption.

3. An oxygen scavenger/indicator according to claim 2, wherein the electromagnetic absorption relates to the microwave, IR, visible or UV range.

4. An oxygen scavenger/indicator according to claim 1 wherein the change in physical properties is a colour change in the oxygen sorbent.

5. An oxygen scavenger/indicator according to claim 1 wherein the metal is selected from the group comprising iron, zinc, aluminium, cobalt, nickel, copper, magnesium, chromium and tin.

6. An oxygen scavenger/indicator according to claim 1 wherein the redox indicator or complexing agent is selected from the group comprising 2,2′-bipyridine, phenanthroline, phenanthroline hydrochloride, ethylene diaminetetraacetic acid (EDTA), potassium hexacyanoferrate (II), potassium hexacyanoferrate (III), potassium thiocyanate, salicylic acid, methylsalicylate, sulphosalicylic acid, acetylsalicylic acid, ethylacetoacetate, phosphorus acid, catechin, benzcatechin, hydroquinone, resorcinol, gallic acid and pyrogallol.

7. An oxygen scavenger/indicator according to claim 1 wherein the electrolyte is selected from the group of alkali and alkaline earth metal halogenides, metallic and non-metallic sulphates and phosphates and non-metallic halogenides.

8. An oxygen scavenger/indicator according to claim 1 wherein the electrolyte is a polymer electrolyte with salts.

9. An oxygen scavenger/indicator according to claim 1 wherein the electrolyte is a gel electrolyte.

10. An oxygen scavenger/indicator according to claim 1 wherein iron is contained as oxygen sorbent and, as redox indicator, a redox indicator for oxidation of Fe(0) into Fe(II) or a complexing agent for Fe(II).

11. An oxygen scavenger/indicator according to claim 1 wherein iron is contained as oxygen sorbent and, as redox indicator, a redox indicator for oxidation of Fe(0) into Fe(III) or a complexing agent for Fe(III).

12. An oxygen scavenger/indicator according to claim 1 wherein an Fe(II) salt is contained as oxygen sorbent and, as redox indicator, a redox indicator for oxidation of Fe(II) into Fe(III) or, as complexing agent, a complexing agent for Fe(III).

13. An oxygen scavenger/indicator according to claim 1 wherein iron is contained as oxygen sorbent and, as redox indicator, respectively one redox indicator for oxidation of Fe(0) into Fe(II) and oxidation of Fe(II) into Fe(III) or, as complexing agent, respectively one complexing agent for Fe(II) and for Fe(III).

14. An oxygen scavenger/indicator according to claim 1 wherein the oxygen scavenger/indicator comprises up to 60 to 94.5% by weight of the at least one oxygen sorbent and up to 5 to 30% by weight of the at least one redox indicator or complexing agent and up to 0.5 to 10% by weight of the at least one electrolyte.

15. An oxygen scavenger/indicator according to claim 1 wherein the oxygen scavenger/indicator comprises up to 15 to 69.5% by weight of the at least one oxygen sorbent and up to 30 to 75% by weight of the at least one redox indicator or complexing agent and up to 0.5 to 10% by weight of the at least one electrolyte.

16. An oxygen scavenger/indicator according to claim 1 wherein the oxygen scavenger/indicator comprises up to 30 to 70% by weight of oxygen sorbent, up to 10 to 20% by weight of the Fe(II) complexing agent and up to 20 to 40% by weight of the Fe(III) complexing agent.

17. An oxygen scavenger/indicator according to claim 1 wherein an activator for the oxygen sorbent is contained.

18. An oxygen scavenger/indicator according to claim 17, wherein the activator is selected from the group chromium, silver, gold, copper and tin.

19. An oxygen scavenger/indicator according to claim 1 wherein the weight ratio of oxygen sorbent to redox indicator and/or complexing agent and electrolyte is adjusted such that the oxygen scavenger/indicator has a change in at least one of its physical properties at a defined point which reproduces the residual capacity of the oxygen sorbent.

20. An oxygen scavenger/indicator according to claim 19, wherein the weight ratio of oxygen sorbent to redox indicator and/or complexing agent and electrolyte is adjusted such that the oxygen scavenger/indicator has a colour change point which reproduces the residual capacity of the oxygen sorbent.

21. An oxygen scavenger/indicator according to claim 1 wherein the weight ratio of oxygen sorbent to redox indicator and/or complexing agent and electrolyte is adjusted such that the oxygen scavenger/indicator has a change in at least one physical property at a defined point which indicates that a specific oxygen concentration is exceeded.

22. An oxygen scavenger/indicator according to claim 21, wherein the weight ratio of oxygen sorbent to redox indicator and/or complexing agent and electrolyte is adjusted such that the oxygen scavenger/indicator has a colour change point which indicates that a specific oxygen concentration is exceeded.

23. An oxygen scavenger/indicator according to claim 1 wherein the weight ratio of oxygen sorbent to redox indicator and/or complexing agent and electrolyte is adjusted such that the oxygen scavenger/indicator has a change in its physical properties at a defined point which indicates that a specific oxygen concentration timespan is exceeded.

24. An oxygen scavenger/indicator according to claim 23, wherein the weight ratio of oxygen sorbent to redox indicator and/or complexing agent and electrolyte is adjusted such that the oxygen scavenger/indicator has a colour change point which indicates that a specific oxygen concentration timespan is exceeded.

25. An oxygen scavenger/indicator according to claim 1 wherein at least one of the components of the oxygen scavenger/indicator is present in encapsulated form.

26. A composite system containing at least one carrier layer and at least one oxygen scavenger/indicator according to claim 1.

27. A composite system according to claim 26, wherein the at least one oxygen scavenger/indicator is enclosed between at least one carrier layer and at least one further layer in the manner of a sandwich.

28. A composite system according to claim 27, wherein the at least one carrier layer represents a barrier layer for oxygen and the at least one further layer is at least partially permeable for oxygen.

29. A composite system according to claim 27, wherein the at least one further layer is modified by foaming and/or stretching.

30. A composite system according to claim 26 wherein the at least one oxygen scavenger/indicator is disposed in solid, disperse or dissolved form at points between the at least one carrier layer and the at least one further layer.

31. A composite system according to one claim 26 wherein the at least one oxygen scavenger/indicator is disposed in solid, disperse or dissolved form in a planar manner between the at least one carrier layer and the at least one further layer.

32. A composite system according to claim 26 wherein the at least one oxygen scavenger/indicator is embedded in a polymer layer.

33. A composite system according to claim 26 wherein the at least one oxygen scavenger/indicator is embedded in an adhesive backing layer, in a paint layer or in a printed ink layer.

34. A composite system according to claim 26 wherein the layer which contains the at least one oxygen scavenger/indicator and/or the at least one further layer is modified by addition of polar or non-polar additives.

35. A composite system according to claim 26 in the form of a packaging film or partially applied individual film.

36. A method of making a packaging film, partially applied individual film for foodstuffs comprising a composite system according to claim 26.
